(19) United States
(12) Patent Application Publication
(10) Pub. No.: US 2026/0361156 A1
(43) Pub. Date: Nov. 12, 2026

(54) MAGNETIC FLUID FOR ACTIVE LIQUID COOLING IN ELECTRICAL MACHINES

(71) Applicant: Raytheon Company, Arlington, VA (US)

(72) Inventors: Hamid Reza Ghazizadeh Karani, Providence, RI (US); Abbas A. Alahyari, Glastonbury, CT (US); Parikshith Channegowda, Marlborough, CT (US)

(21) Appl. No.: 19/204,009

(22) Filed: May 9, 2025

(51) Int. Cl. H02K 1/20; C09K 5/10; H01F 1/44; H02K 3/24

(52) U.S. Cl. CPC H02K 1/20; C09K 5/10; H01F 1/44; H02K 3/24

(57) ABSTRACT

A stator of an electric machine includes a stator core including a stator back iron, and a plurality of stator shoes extending radially from the stator back iron and defining a plurality of stator winding slots. An electrically conductive winding is positioned in the plurality of stator winding slots. A cooling arrangement includes a plurality of cooling fluid channels extending through the stator core and a cooling fluid circulated along the plurality of cooling fluid channels. The cooling fluid includes a plurality of active ferromagnetic particles suspended in a liquid. An electromagnetic field of the electric machine when operated, activates the plurality of ferromagnetic particles to induce turbulence in the cooling fluid.

### BACKGROUND

Exemplary embodiments pertain to the art of electric machines, such as motors or generators. In particular, the present disclosure relates to fluid cooling of electric machines.

Electric machines are critical components for more electric/ hybrid-electric aircrafts, and increasing power density of electrical machines is essential to achieve future aircraft electrification efforts. Power density in electrical machines is constrained by thermal loading, and improving the thermal management system (TMS) directly helps to improve power density. There are multiple cooling techniques typically used in electric machine, such as air cooling with stator fins and indirect jacket air flow, oil spray cooling, liquid jacket cooling and direct stator/rotor slot cooling.

The direct slot cooling methods require close contact between the stator/rotor conductors and liquid coolant which is achieved by additively manufactured embedded cooling slot channels. The disadvantage with embedded slot channel cooling is that these cooling channels occupy space in the stator/rotor that is unavailable for slot wiring. These embedded slot channels sometimes utilize two-phase coolants that are effective for heat transfer, but can pose challenges such as maldistribution, high pressure, and controllability and may not be appropriate for every application.

There is a need for new methods that can further increase the heat flux with embedded or liquid jacket cooling methods. Thermal transport (and heat transfer coefficient) can be enhanced by increasing flow rate, reducing flow temperature or enhancing turbulence and mixing in liquid flow

### BRIEF DESCRIPTION

In one embodiment, a stator of an electric machine includes a stator core including a stator back iron, and a plurality of stator shoes extending radially from the stator back iron and defining a plurality of stator winding slots. An electrically conductive winding is positioned in the plurality of stator winding slots. A cooling arrangement includes a plurality of cooling fluid channels extending through the stator core and a cooling fluid circulated along the plurality of cooling fluid channels. The cooling fluid includes a plurality of active ferromagnetic particles suspended in a liquid. An electromagnetic field of the electric machine when operated, activates the plurality of ferromagnetic particles to induce turbulence in the cooling fluid.

Additionally or alternatively, in this or other embodiments activating the plurality of ferromagnetic particles includes urging rotation of the plurality of ferromagnetic particles in the liquid.

Additionally or alternatively, in this or other embodiments the plurality of cooling fluid channels are positioned in the plurality of stator winding slots.

Additionally or alternatively, in this or other embodiments the plurality of cooling fluid channels are positioned in the plurality of stator shoes.

Additionally or alternatively, in this or other embodiments the plurality of cooling fluid channels are positioned in the stator back iron radially outboard of the plurality of stator winding slots.

Additionally or alternatively, in this or other embodiments a heat exchanger positioned in fluid communication with the plurality of cooling fluid channels is configured to remove thermal energy from the cooling fluid.

Additionally or alternatively, in this or other embodiments the active ferromagnetic particles are configured to improve a distribution of an electromagnetic flux in the plurality of core slots.

In another embodiment, an electric machine includes a rotor rotatable about an axis of rotation, and a stator including a stator core having a stator back iron and a plurality of stator shoes extending radially from the stator back iron defining a plurality of stator winding slots between adjacent stator shoes of the plurality of stator shoes. An electrically conductive winding is positioned in the plurality of stator winding slots. The electrically conductive winding is electromagnetically interactive with the rotor. A cooling arrangement of the electric machine includes a plurality of cooling fluid channels extending through the electric machine and a cooling fluid circulated along the plurality of cooling fluid channels. The cooling fluid includes a plurality of active ferromagnetic particles suspended in a liquid. An electromagnetic field of the electric machine when operated, activates the plurality of ferromagnetic particles to induce turbulence in the cooling fluid.

Additionally or alternatively, in this or other embodiments activating the plurality of ferromagnetic particles includes urging rotation of the plurality of ferromagnetic particles in the liquid.

Additionally or alternatively, in this or other embodiments the plurality of cooling fluid channels are positioned in the stator core.

Additionally or alternatively, in this or other embodiments the plurality of cooling fluid channels are positioned in the plurality of stator winding slots.

Additionally or alternatively, in this or other embodiments the plurality of cooling fluid channels are positioned in the plurality of stator shoes.

Additionally or alternatively, in this or other embodiments the plurality of cooling fluid channels are positioned in the stator back iron radially outboard of the plurality of stator winding slots.

Additionally or alternatively, in this or other embodiments the active ferromagnetic particles are configured to improve distribution of an electromagnetic flux in the plurality of core slots.

Additionally or alternatively, in this or other embodiments a heat exchanger in fluid communication with the plurality of cooling fluid channels is configured to remove thermal energy from the cooling fluid.

In yet another embodiment, a method of operating an electric machine includes energizing an electrically conductive winding of a stator of the electric machine, driving rotation of a rotor about a rotation axis via an electromagnetic interaction between the stator and the rotor, and circulating a cooling fluid through a plurality of cooling channels defined in the stator. The cooling fluid includes a plurality of active ferromagnetic particles suspended in a liquid. The plurality of ferromagnetic particles are activated via an electromagnetic field of the electric machine when operated, thereby inducing turbulence in the cooling fluid.

Additionally or alternatively, in this or other embodiments activating the plurality of ferromagnetic particles includes urging rotation of the plurality of ferromagnetic particles in the liquid.

Additionally or alternatively, in this or other embodiments the plurality of cooling fluid channels are positioned in a stator core of the stator.

Additionally or alternatively, in this or other embodiments the active ferromagnetic particles are configured to improve distribution of an electromagnetic flux in the stator.

Additionally or alternatively, in this or other embodiments thermal energy is removed from the cooling fluid via a heat exchanger in fluid communication with the plurality of cooling fluid channels.

### BRIEF DESCRIPTION OF THE DRAWINGS

The following descriptions should not be considered limiting in any way. With reference to the accompanying drawings, like elements are numbered alike:

FIG. 1 is a cross-sectional view of an exemplary embodiment of an electric machine;

FIG. 2 is a cross-sectional view of an exemplary embodiment of a stator core of an electric machine;

FIG. 3 is a cross-sectional view of another exemplary embodiment of a stator core of an electric machine; and

FIG. 4 is a cross-sectional view of yet another exemplary embodiment of a stator core of an electric machine.

### DETAILED DESCRIPTION

A detailed description of one or more embodiments of the disclosed apparatus and method are presented herein by way of exemplification and not limitation with reference to the Figures.

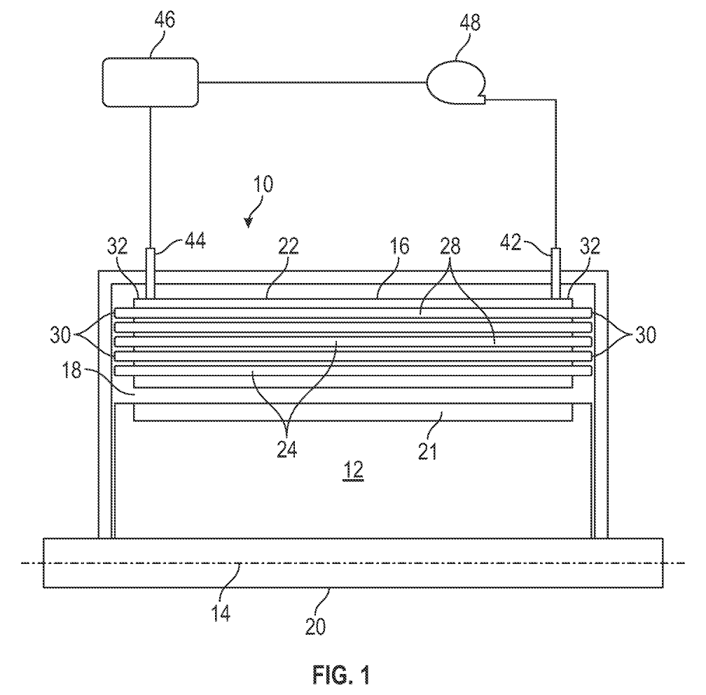

Illustrated in FIG. 1 is a cross-sectional view of an exemplary embodiment of an electric machine 10. The electric machine 10 includes a rotor 12 configured to rotate about a rotation axis 14. A stator 16 is located radially outboard of the rotor 12 relative to the rotation axis 14, with a radial air gap 18 located between the rotor 12 and the stator 14. In some embodiments, the rotor 12 is mounted on a rotor shaft 20. The rotor 12 and the rotor shaft 20 may be fixed together such that the rotor 12 and the rotor shaft 20 rotate about the rotation axis 14 together as one piece. In some embodiments, the rotor 12 further includes a plurality of permanent magnets 21 arranged thereon. The stator 16 includes a stator core 22 in which a plurality of electrically conductive stator windings 24 are disposed. In some embodiments, such as shown in FIG. 1, the stator core 22 is formed from a plurality of axially stacked laminations, which are stacked along the rotation axis 14. In some embodiments, the laminations are formed from a steel material, but one skilled in the art will readily appreciate that other materials may be utilized. The stator windings 24 include core segments 28 extending through the stator core 22 and end turn segments 30 extending from each axial stator end 32 of the stator core 22 and connecting circumferentially adjacent core segments 28. When the stator windings 24 are energized via an electrical current therethrough, the magnetic field produced by the stator winding 24 interacts with the magnetic field from the permanent magnets 21 on the rotor 12 to produce rotational torque of the rotor 12. Lines indicating instantaneous magnetic fluxes operating in the electrical machine 10 are shown at 50. While in the description herein, the electric machine 10 is configured as a motor, in other embodiments, the electric machine 10 may be configurated as a generator, wherein rotation of the rotor 12 about the rotation axis 14 energizes the stator windings 24 thus generating electrical energy. Additionally, while the electric machine 10 has a stator 16 located radially outboard of the rotor 12, one skilled in the art will readily appreciate that the present disclosure may be readily applied to other configurations, such as those where the rotor 12 is positioned radially outboard of the stator 16.

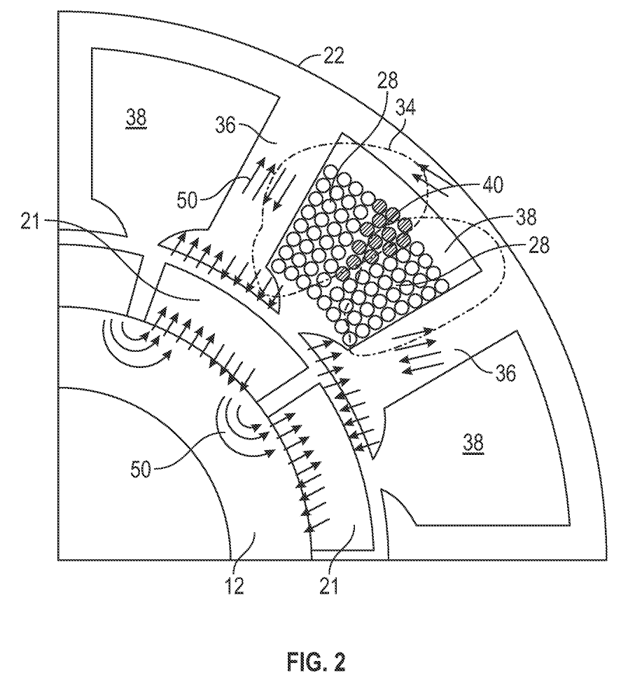

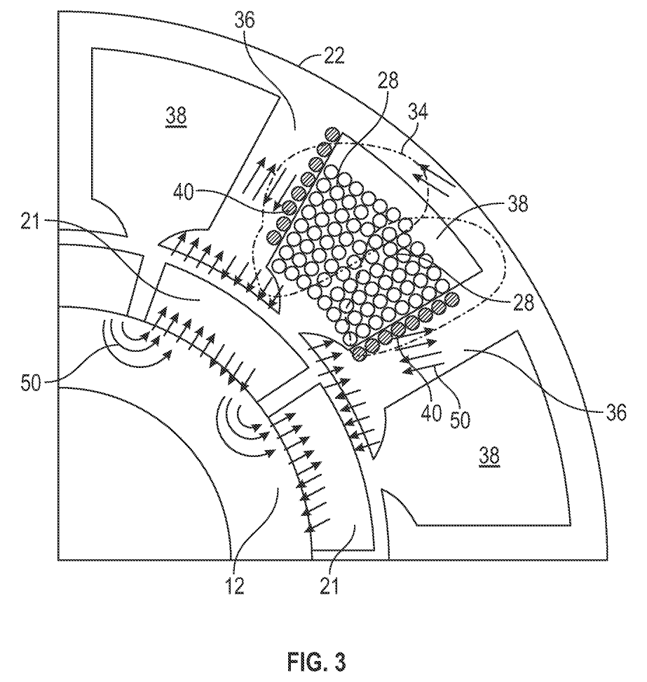

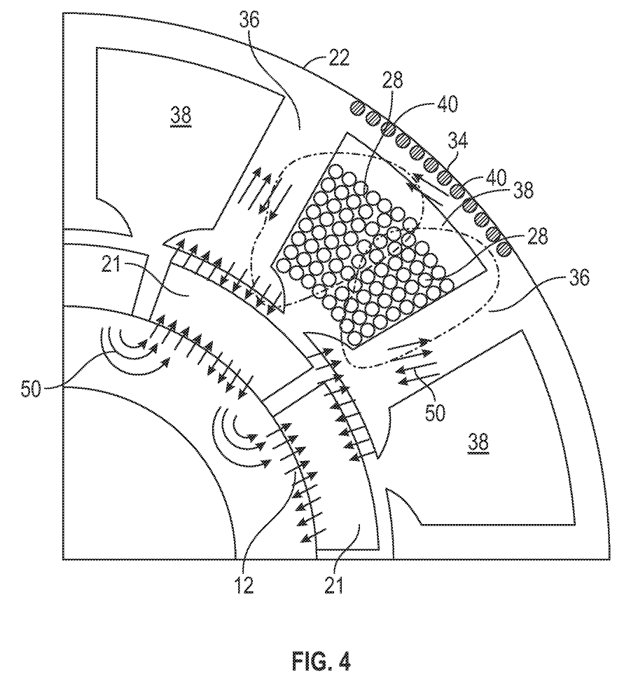

Referring now to FIG. 2, the stator core 22 includes a stator back iron 34 with a plurality of stator shoes 36 extending radially inwardly from the core rim 34, defining stator slots 38. The core segments 28 of the stator winding 24 extend along the axial length of the stator slot 38. The stator core 22 includes a plurality of cooling channels 40 through which a volume of cooling fluid is circulated to cool the stator winding 24. In some embodiments, such as illustrated in FIG. 2, the cooling channels 40 are positioned in the core slots 38 and extend axially along the core slots 38. This location of the cooling channels 40, however, is merely exemplary, and in other embodiments the cooling channels 40 may be positioned at other locations in the stator core 22. For example, as illustrated in FIG. 3, in some embodiments the cooling channels 40 may be located in the stator shoes 36 closest to the winding 38. In another exemplary embodiment illustrated in FIG. 4, the cooling channels 40 are located in the stator back iron 34. In all embodiments, as illustrated in FIG. 1, the stator core 22 includes a coolant inlet 42 and a coolant outlet 44 connected to the cooling channels 40. The cooling fluid enters the cooling channels 40 at the coolant inlet 42 and exits the cooling channels 40 at the coolant outlet 44. A heat exchanger 46 is connected to the coolant outlet 44 to reject the heat from the cooling fluid before the cooling fluid to the coolant inlet 42. In some embodiments, a coolant pump 48 is utilized to drive circulation of the cooling fluid.

As previously stated, cooling fluid is circulated through the cooling channels 40 to cool the stator winding 24. The cooling fluid is an active ferrofluid, comprising active ferromagnetic particles in a liquid suspension. The ferrofluid is utilized to enhance turbulence in the cooling fluid, improving mixing of the cooling fluid and increasing heat transfer rate. The pre-existing rotating magnetic field of the operating electric machine 10 exerts magnetohydrodynamic torque on the ferromagnetic particles of the cooling fluid to induce spin into the ferromagnetic particles of the cooling fluid. In some embodiments, the rate of spin of the ferromagnetic particles is in the range of 10rpm to 1000rpm, but this range is merely exemplary. The rate of spin may be modulated by tuning, for example, magnetic properties of the ferromagnetic particles, size of the ferromagnetic particles, and physical properties of the liquid suspension of the cooling fluid. The spin of the ferromagnetic particles induces turbulence in the cooling fluid, which improves heat transfer rate of the cooling fluid, in some embodiments up to 7 times greater than a typical cooling fluid. This enhanced cooling capacity can allow for increased power density of the electric motor 10.

Additionally, utilizing active ferrofluid as the cooling fluid additionally improves magnetic field distribution in the stator slots 38 shown, for example, in FIGS. 2 and 3, when compared to traditional coolants. Traditional slot coolants have no magnetic properties and provide a magnetic reluctance the same as air. Active ferromagnetic coolants can be engineered with relative permittivity close to the stator core 22 material. This reduces the overall magnetic reluctance in the flux path, reduces loss and therefore improves the magnetic field distribution.

In the current disclosure, cooling channels in the electric machine 10 are used in conjunction with a cooling fluid including magnetically active particles in a liquid suspension where the existing rotating magnetic field of the motor is leveraged to activate the suspended particles in the flow. While the description above is in the context of cooling fluid flowed through a stator 16, one skilled in the art will readily appreciate that in other embodiments, the cooling fluid may be flowed through the rotor 12 of the electric machine 10 to cool the rotor 12. The magnetic particles of the cooling fluid are activated to spin and enhance mixing in the liquid coolant. The cooling channels 40 may be connected to an external cooling loop or act locally to extract heat from the winding 24 to an external heat sink. The cooling fluid may be utilized with single- or two-phase coolants and can be tuned to the frequency and field magnitude of the motor/generator. Ferromagnetic coolants have relative permeability close to the stator material, thus they have the potential to reduce overall reluctance in the flux path. The proposed approach provides an augmented cooling effect with tunable property for handling time-variable thermal loadings.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A stator of an electric machine, comprising:
a stator core including:
a stator back iron; and
a plurality of stator shoes extending radially from the stator back iron and defining a plurality of stator winding slots;
an electrically conductive winding disposed in the plurality of stator winding slots; and
a cooling arrangement, including:
a plurality of cooling fluid channels extending through the stator core; and
a cooling fluid circulated along the plurality of cooling fluid channels, the cooling fluid comprising a plurality of active ferromagnetic particles suspended in a liquid;
wherein an electromagnetic field of the electric machine when operated, activates the plurality of ferromagnetic particles to induce turbulence in the cooling fluid.

2. The stator of claim 1, wherein activating the plurality of ferromagnetic particles comprises urging rotation of the plurality of ferromagnetic particles in the liquid.

3. The stator of claim 1, wherein the plurality of cooling fluid channels are disposed in the plurality of stator winding slots.

4. The stator of claim 1, wherein the plurality of cooling fluid channels are disposed in the plurality of stator shoes.

5. The stator of claim 1, wherein the plurality of cooling fluid channels are disposed in the stator back iron radially outboard of the plurality of stator winding slots.

6. The stator of claim 1, further comprising a heat exchanger in fluid communication with the plurality of cooling fluid channels configured to remove thermal energy from the cooling fluid.

7. The stator of claim 1, wherein the active ferromagnetic particles are configured to improve a distribution of an electromagnetic flux in the plurality of core slots.

8. An electric machine, comprising:
a rotor rotatable about an axis of rotation;
a stator including:
a stator core having:
a stator back iron; and
a plurality of stator shoes extending radially from the stator back iron defining a plurality of stator winding slots between adjacent stator shoes of the plurality of stator shoes; and
an electrically conductive winding disposed in the plurality of stator winding slots, the electrically conductive winding electromagnetically interactive with the rotor;
a cooling arrangement of the electric machine including:
a plurality of cooling fluid channels extending through the electric machine; and
a cooling fluid circulated along the plurality of cooling fluid channels, the cooling fluid comprising a plurality of active ferromagnetic particles suspended in a liquid;
wherein an electromagnetic field of the electric machine when operated, activates the plurality of ferromagnetic particles to induce turbulence in the cooling fluid.

9. The electric machine of claim 8, wherein activating the plurality of ferromagnetic particles comprises urging rotation of the plurality of ferromagnetic particles in the liquid.

10. The electric machine of claim 8, wherein the plurality of cooling fluid channels are disposed in the stator core.

11. The electric machine of claim 10, wherein the plurality of cooling fluid channels are disposed in the plurality of stator winding slots.

12. The electric machine of claim 10, wherein the plurality of cooling fluid channels are disposed in the plurality of stator shoes.

13. The electric machine of claim 10, wherein the plurality of cooling fluid channels are disposed in the stator back iron radially outboard of the plurality of stator winding slots.

14. The electric machine of claim 10, wherein the active ferromagnetic particles are configured to improve distribution of an electromagnetic flux in the plurality of core slots.

15. The electric machine of claim 8, further comprising a heat exchanger in fluid communication with the plurality of cooling fluid channels configured to remove thermal energy from the cooling fluid.

16. A method of operating an electric machine, comprising:
energizing an electrically conductive winding of a stator of the electric machine;
driving rotation of a rotor about a rotation axis via an electromagnetic interaction between the stator and the rotor; and
circulating a cooling fluid through a plurality of cooling channels defined in the stator, the cooling fluid comprising a plurality of active ferromagnetic particles suspended in a liquid;
activating the plurality of ferromagnetic particles via an electromagnetic field of the electric machine when operated, thereby inducing turbulence in the cooling fluid.

17. The method of claim 16, wherein activating the plurality of ferromagnetic particles comprises urging rotation of the plurality of ferromagnetic particles in the liquid.

18. The method of claim 16, wherein the plurality of cooling fluid channels are disposed in a stator core of the stator.

19. The method of claim 16 wherein the active ferromagnetic particles are configured to improve distribution of an electromagnetic flux in the stator.

20. The method of claim 16, further comprising removing thermal energy from the cooling fluid via a heat exchanger in fluid communication with the plurality of cooling fluid channels.
